(19) United States
(12) Patent Application Publication
(10) Pub. No.: US 2008/0080336 A1
(43) Pub. Date: Apr. 3, 2008

(54) Optical disk reproducing apparatus and optical disk reproducing method

(75) Inventors: Reiko Kawachi, Nishitama-gun (JP); Manabu Koarai, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/902,851

(22) Filed: Sep. 26, 2007

(30) Foreign Application Priority Data
Sep. 28, 2006 (JP) 2006-265788

(51) Int. Cl. G11B 7/00

(52) U.S. Cl. 369/44.23

(57) ABSTRACT

According to one embodiment, there is provided an optical disk reproducing apparatus including a read unit which outputs read information based on a reflected beam of a laser beam irradiated on an optical disk, an extracting unit which extracts URL information from the read information from the read unit, a communication unit which communicates with an external apparatus through a network, and a control unit which, when the extracting unit detects the URL information, compares the URL information with URL information of an access blocking list, downloads a resource through the communication unit depending on the URL information when the URL information is not included in the access blocking list, and stops access when the URL information is included in the access blocking list.

### CROSS-REFERENCE TO RELATED APPLICATION

This application is based upon and claims the benefit of priority from Japanese Patent Application No. 2006-265788, filed Sep. 28, 2006, the entire contents of which are incorporated herein by reference.

### BACKGROUND

1. Field

One embodiment of the present invention relates to an optical disk reproducing apparatus and an optical disk reproducing method for downloading information from an external apparatus by using a URL (Uniform Resource Locator) stored in an optical disk.

2. Description of the Related Art

In recent years, optical disks have been developed and widely used, and optical disk reproducing apparatuses having various functions are devised. As one of the functions, a function of accessing a site or the like on a network depending on URL information included in stored information in an optical disk to download the information is known. However, some users do not want to access a specific site (for example, a site including violence expressions or a site for adults).

Patent Document 1 (Jpn. Pat. Appln. KOKAI Publication No. 2005-316709) discloses that access blocking to a Web site which can be accessed by communication means of a recording/reproducing apparatus is set depending on ID information of a user. More specifically, a Web site blocked from being accessed is registered for each piece of ID information in advance. When the recording/reproducing apparatus receives ID information from a user and an address of a Web site, the recording/reproducing apparatus determines whether the Web site is registered in a blocking management table. As a result, when the Web site is registered in the blocking management table, the recording/reproducing apparatus does not allow the user to access the Web site.

However, in the conventional art of Patent Document 1, URL information is independently given. For this reason, when URL information is given from the contents of an optical disk, it cannot be understood how to perform access blocking.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an example of a configuration of a disk reproducing apparatus according to an embodiment of the present invention;

FIG. 2 is an explanatory diagram showing an example of URL information stored in a disk from which data is read by the disk reproducing apparatus according to the embodiment of the present invention;

FIG. 3 is an explanatory diagram showing an example of an access blocking button realized by a remote controller of the disk reproducing apparatus according to the embodiment of the present invention;

FIG. 4 is an explanatory diagram showing an example of an access blocking table of the disk reproducing apparatus according to the embodiment of the present invention;

FIG. 5 is an explanatory diagram showing an example of a parental lock list access log-in screen of the disk reproducing apparatus according to the embodiment of the present invention;

FIG. 6 is an explanatory diagram showing an example of a screen which informs a user of access blocking of the disk reproducing apparatus according to the embodiment of the present invention;

FIG. 7 is a flow chart showing an example of a registration process of a URL blocked from being accessed by the disk reproducing apparatus according to the embodiment of the present invention; and

FIG. 8 is a flow chart showing an example of an access blocking process in the disk reproducing apparatus according to the embodiment of the present invention.

### DETAILED DESCRIPTION

Various embodiments according to the invention will be described hereinafter with reference to the accompanying drawings. In general, according to one embodiment of the invention, an optical disk reproducing apparatus comprising: a read unit which outputs read information based on a reflected beam of a laser beam irradiated on an optical disk; an extracting unit which extracts URL information from the read information from the read unit; a communication unit which communicates with an external apparatus through a network; and a control unit which, when the extracting unit detects the URL information, compares the URL information with URL information of an access blocking list, downloads a resource through the communication unit depending on the URL information when the URL information is not included in the access blocking list, and stops access when the URL information is included in the access blocking list.

An embodiment according to the present invention relates to an optical disk reproducing apparatus and an optical disk reproducing method which can block access to a resource of a URL designated by optical disk contents.

One embodiment for achieving the object of the invention is an optical disk reproducing apparatus comprising:

a read unit (19) which outputs read information based on a reflected beam of a laser beam irradiated on an optical disk;

an extracting unit (34) which extracts URL information from the read information from the read unit;

a communication unit (11) which communicates with an external apparatus through a network; and

a control unit (30, 34) which, when the extracting unit detects the URL information, compares the URL information with URL information of an access blocking list (35), downloads a resource through the communication unit depending on the URL information when the URL information is not included in the access blocking list, and stops access when the URL information is included in the access blocking list.

In this manner, there are provided an optical disk reproducing apparatus and an optical disk reproducing method in which a user can arbitrarily block access to the resource of the URL designated by the optical disk contents.

The embodiment of the present invention will be described below in detail with reference to the accompanying drawings.

<Optical Disk Reproducing Apparatus according to One Embodiment of the Present Invention>

(Configuration)

In this case, an optical disk reproducing apparatus according to an embodiment of the present invention will be described below by using an optical disk recording/reproducing apparatus having a hard disk recorder function as an example. However, the optical disk reproducing apparatus includes various configurations, all of which are included in the scope of the embodiment of the present invention.

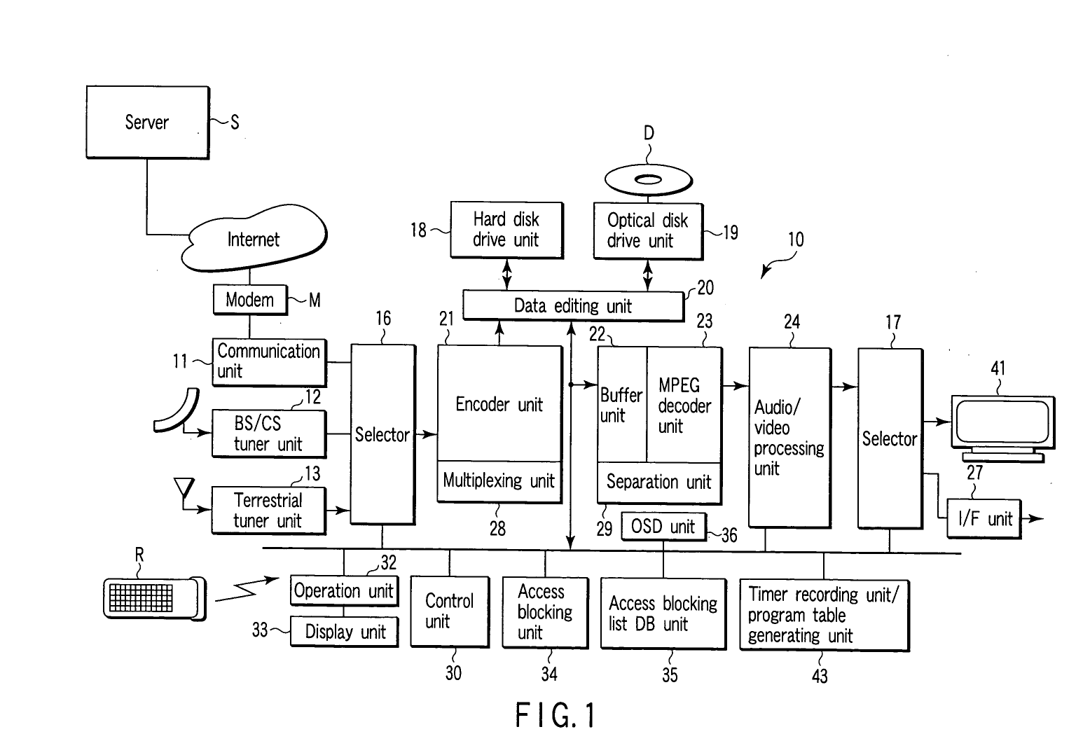

FIG. 1 is a block diagram showing an example of a configuration of the optical disk reproducing apparatus according to an embodiment of the present invention. An optical disk reproducing apparatus 10 in FIG. 1 has disk drive units of two types. Specifically, the optical disk reproducing apparatus 10 has an optical disk drive unit 19 which rotationally drives an optical disk D, a first medium serving as an information recording medium which can structure a video file, i.e., HD_DVD (High Definition Digital Versatile Disk), a normal DVD (Digital Versatile Disc), or the like to execute reading/writing of information. The optical disk reproducing apparatus 10 also has a hard disk drive unit 18 which drives a hard disk serving as a second medium. A control unit 30 is connected to the respective units through data buses to control an overall operation.

The optical disk reproducing apparatus 10 in FIG. 1 includes an encoder unit 21 constituting a recording side, an MPEG decoder unit 23 constituting a reproducing side, and the control unit 30 which controls an operation of the apparatus main body as main constituent elements. The optical disk reproducing apparatus 10 has an input-side selector 16 and an output-side selector 17. A communication unit 11 such as a LAN, a so-called satellite broadcasting (BS/CS) tuner unit 12, and a so-called terrestrial tuner unit 13 are connected to the input-side selector 16. The input-side selector 16 outputs a signal to the encoder unit 21. A satellite antenna is connected to the BS/CS tuner unit 12, and a terrestrial antenna is connected to the terrestrial tuner unit 13. The optical disk reproducing apparatus 10 has the encoder unit 21, a data editing unit 20 which receives an output from the encoder unit 21 and performs desired data processing such as data editing, the hard disk drive unit 18 connected to the data editing unit 20, and the optical disk drive unit 19. Furthermore, the optical disk reproducing apparatus 10 has the hard disk drive unit 18, the MPEG decoder unit 23 which receives a signal from the optical disk drive unit 19 to decode the signal, the encoder unit 21, a buffer unit 22, the MPEG decoder unit 23, a multiplexing unit 28, a separation unit 29, the control unit 30, an access blocking unit 34, an access blocking list DB unit 35, an OSD (on screen display) unit 36, and a timer recording unit/program table generating unit 43. The respective units are connected to the control unit 30 through data buses. Furthermore, an output from the selector 17 is connected to an external receiver 41 or supplied to an external apparatus through an interface unit 27 which communicates with the external apparatus.

Furthermore, the optical disk reproducing apparatus 10 has an operation unit 32 which is connected to the control unit 30 through a data bus, and receives an operation from a user and an operation from a remote controller R. In this case, the remote controller makes it possible to realize operations almost equivalent to those of the operation unit 32 arranged on the main body of the optical disk reproducing apparatus 10 and can perform recording/reproducing designation of the hard disk drive unit 18 or the optical disk drive unit 19, editing designation, an operation of a tuner, and various settings such as a setting of timer recording.

(Basic Operation)

In the optical disk reproducing apparatus 10 having the above configuration, outlines of a reproducing process and a recording process will be described below with reference to an optical disk. Under the control of the control unit 30, a laser beam is irradiated on an optical disk D rotated at a predetermined speed, a reflected beam from the optical disk D is detected by an optical pickup, and a detection signal based on the beam is output. On the basis of the detection signal, an RF signal is generated, and a reproducing process is performed subsequently to a data read process.

In a recording process for an optical disk, under the control of the control unit 30, data supplied through, for example, an input unit (not shown) and the selector 16 is supplied to the encoder unit 21 and coded and output. Depending on the coded output and an output from the control unit 30, a drive current for a laser driver is supplied to the optical pick-up, and a recording region of the optical disk D is irradiated to perform the recording process.

By using the tuner units 12 and 13, a timer recording unit 42, and the program table generating unit 43, a broadcast signal is timer-recorded on the hard disk drive unit 18, the optical disk D, or the like with reference to an electronic program table and can be reproduced.

<Access Blocking Process Depending on URL>

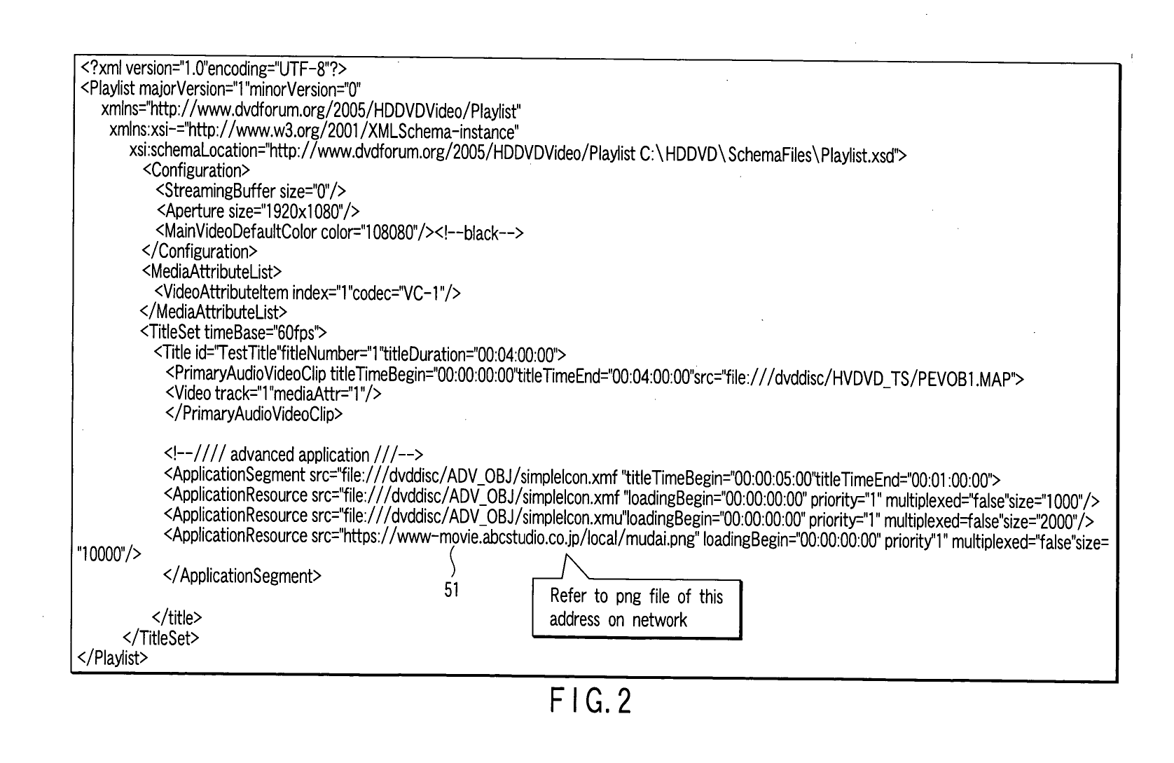

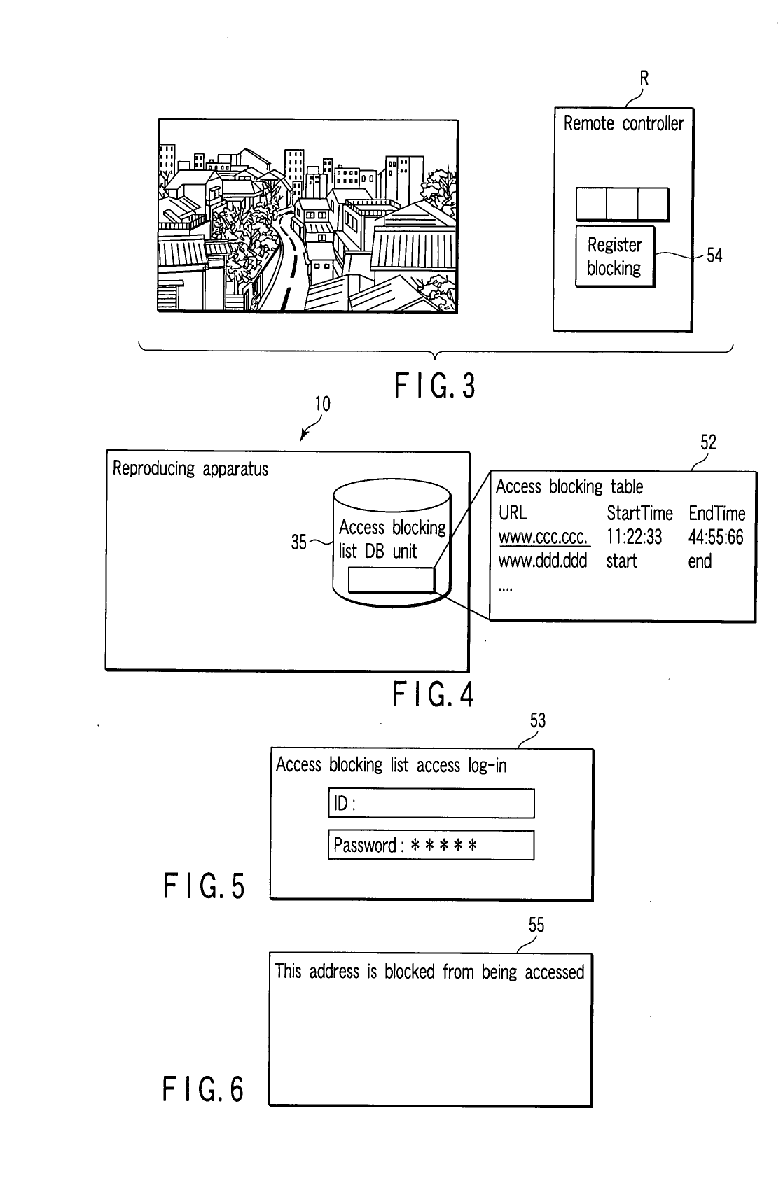

An access blocking process depending on a URL in the optical disk reproducing apparatus will be described below in detail using a flow chart. FIG. 2 is an explanatory diagram showing an example of URL information stored in a disk from which data is read by the disk reproducing apparatus according to the embodiment of the present invention. FIG. 3 is an explanatory diagram showing an example of an access blocking button realized by a remote controller of the disk reproducing apparatus according to the embodiment of the present invention. FIG. 4 is an explanatory diagram showing an example of an access blocking table of the disk reproducing apparatus according to the embodiment of the present invention. FIG. 5 is an explanatory diagram showing an example of a parental lock list access log-in screen of the disk reproducing apparatus according to the embodiment of the present invention. FIG. 6 is an explanatory diagram showing an example of a screen which informs a user of access blocking of the disk reproducing apparatus according to the embodiment of the present invention.

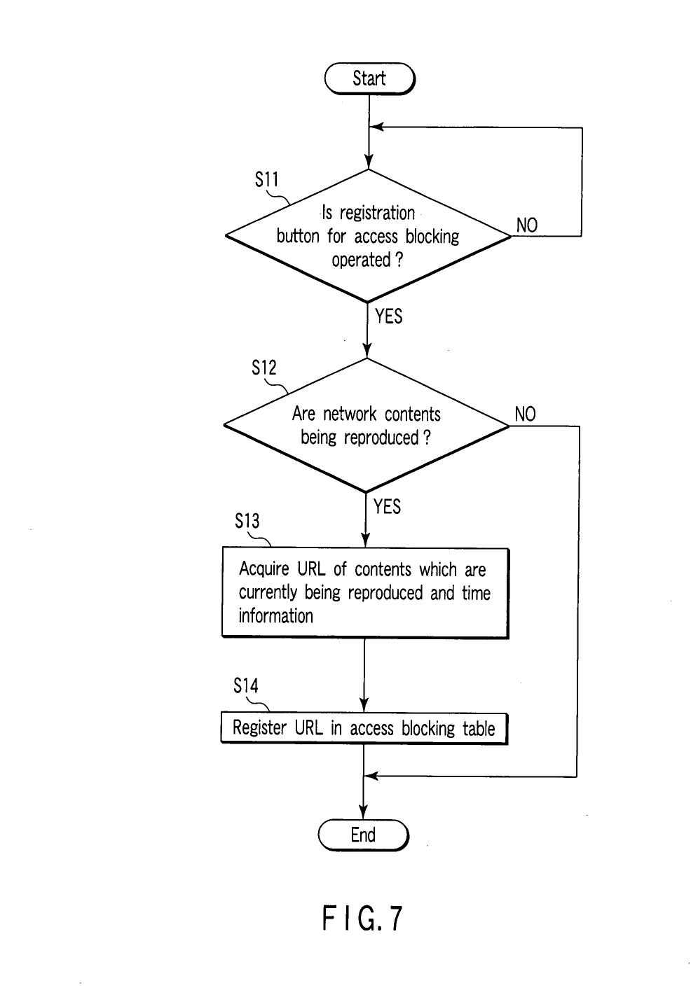

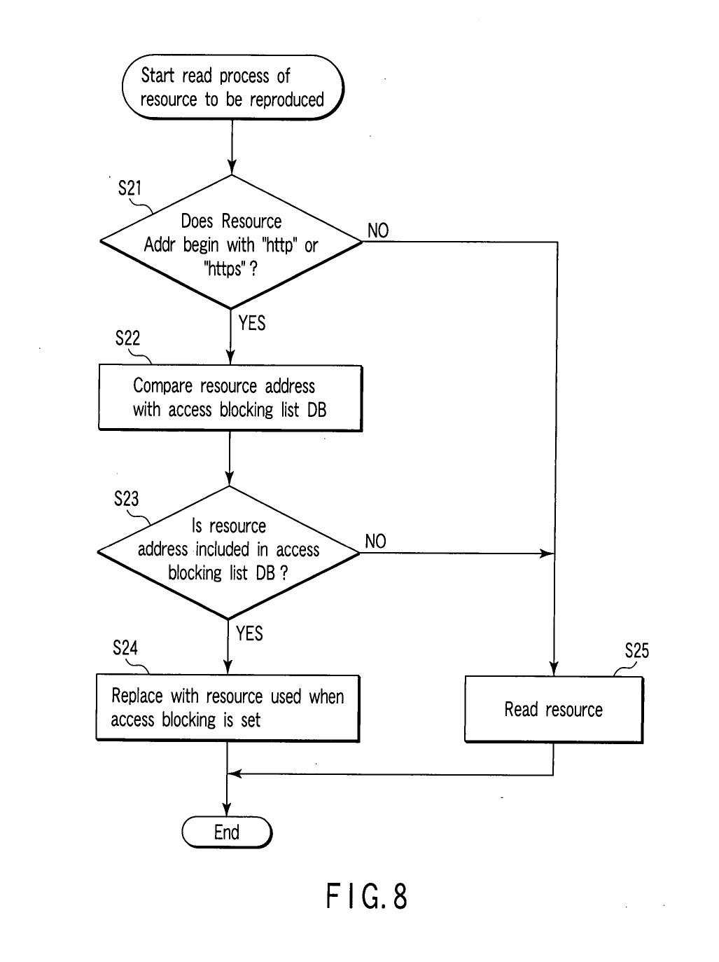

Furthermore, FIG. 7 is a flow chart showing an example of a registration process of a URL blocked from being accessed by the disk reproducing apparatus according to the embodiment of the present invention. FIG. 8 is a flow chart showing an example of an access blocking process in the disk reproducing apparatus according to the embodiment of the present invention.

Steps in the flow charts in FIGS. 7 and 8 can be replaced with circuit blocks. Therefore, all the steps of the flow charts can be redefined as the blocks.

(Registering Process of Access Blocking List: FIG. 7)

First, a registering process of an access blocking list in the disk reproducing apparatus according to the embodiment of the present invention will be described below with reference to the flow chart in FIG. 7.

Before the explanation, a downloading process based on a URL of optical disk contents and performed by the disk reproducing apparatus according to the embodiment of the present invention will be described.

When an optical disk, i.e., an HD_DVD (High Definition Digital Versatile Disk), a normal DVD (Digital Versatile Disk), or the like is inserted into the optical disk drive unit 19, a beam irradiated from an optical pick-up (not shown) and reflected from the optical disk is read by a detector of the optical pick-up to output a read signal. The access blocking unit 34 analyzes the read signal and determines, on the basis of the presence/absence of URL (Uniform Resource Locator) information as shown in FIG. 2, whether a function of downloading and reproducing data from a network is included in the disk.

In this case, as concrete determining methods, there are a method for performing determination by an identification flag, set in the optical disk, to determine whether network access is performed, and a method for performing determination by analyzing an application included in the optical disk.

When the control unit 30 and the access blocking unit 34 determine that the optical disk includes contents to be downloaded, the communication unit 11 accesses a site on a network indicated by URL information to download the contents and performs a process of decoding the downloaded contents.

When downloading depending on the URL of the optical contents is performed, some users may not want to access a specific site (for example, a site including violence expressions or a site for adults). For this purpose, in the disk reproducing apparatus according to the embodiment of the present invention, an access blocking process is performed.

More specifically, in the flow chart in FIG. 7, when access depending on the URL of the optical disk contents is performed by the above procedure, if the user determines the site of the URL as an improper site, for example, as shown in FIG. 3, the user depresses an access blocking registration switch 54 of an remote controller R to register access blocking (step S11). However, these operations are not necessarily performed, and a dedicated switch of the operation unit 32 of the main body of the optical disk recording/reproducing apparatus may be pressed. Another operation method may be used.

When the operation is performed, on the basis of determination by the control unit 30 and the access blocking unit 34, access is performed depending on a URL of optical disk contents at present. In this manner, it is determined whether the network contents are being reproduced (step S12).

When the network contents are being reproduced, the control unit 30 and the access blocking unit 34 acquire the URL of the contents which are currently being reproduced and time information (step S13) and register the URL and the time information in an access blocking list shown in an access blocking table 52 of the access blocking list DB unit 35 shown in FIG. 4 (step S14). In this manner, the URL is registered as a URL blocked by the user from being accessed.

A method of registering a URL in the access blocking list is not limited to the above method, and registration may be performed by the following method. That is, for example, as shown in FIG. 5, a password of the access blocking list is determined, and the access blocking list can be accessed only when an input password coincides with the registered password. The access blocking list may be displayed to directly input a URL, or a URL which is being accessed may be registered.

(Resource Read Process with Access Blocking Process: FIG. 8)

By using the access blocking list DB unit 35 registered and created as described above, a resource read process with an access blocking process will be described below.

First, in the optical disk reproducing apparatus 10 according to the embodiment of the present invention, as shown in the flow chart in FIG. 8, a read process of a resource to be reproduced is started. The control unit 30 and the access blocking unit 34 analyze read information read from an optical disk to determine whether “Resource Addr” begins with “http” or “https” (step S21).

When the read information determines that “Resource Addr” begins with “http” or “https”, the URL of the resource is compared with an address group of an access blocking table of an access blocking list DB (step S22). When the control unit 30 and the access blocking unit 34 determine that the resource address is an address included in the access blocking list DB unit 35 (step S23), the resource is not read by accessing the URL, and the resource is replaced with a resource used when access blocking is set (step S24).

The resource used when access blocking is set is a warning screen 55 or the like given by an OSD unit 36 or the like and shown in FIG. 6. It is preferably displayed that “This address is blocked from being accessed”. However, the resource is not necessarily given by an OSD, and the resource is preferably displayed on a display unit 33 depending on the operation unit 32 of the optical disk reproducing apparatus 10.

When it is not detected in step S21 that “Resource Addr” begins with “http” or “https”, a read process of a contents resource in the optical disk is performed. Furthermore, when the URL detected in step S23 is not included in the access blocking list DB unit 35, a read process of a resource downloaded from the given URL is performed (step S25).

Even though it is displayed in step S24 that “This address is blocked from being accessed”, for example, the same password as the registered password is input on a password screen shown in FIG. 5 to make the URL accessible, and contents can be preferably downloaded from a site indicated by the URL.

According to the method described in detail, with respect to a URL designated by optical disk contents, access blocking can be set to a specific resource depending on user's taste.

According to the various embodiments described above, a person skilled in the art can realize the present invention. Furthermore, a person skilled in the art can easily conceive of various modifications of the embodiments and can apply the invention to various embodiments without inventive ability. Therefore, the present invention ranges in broad scope without departing from the disclosed principles and novel features, and is not limited to the embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk reproducing apparatus comprising:
a read unit which outputs read information based on a reflected beam of a laser beam irradiated on an optical disk;
an extracting unit which extracts URL information from the read information from the read unit;
a communication unit which communicates with an external apparatus through a network; and
a control unit which, when the extracting unit detects the URL information, compares the URL information with URL information of an access blocking list, downloads a resource through the communication unit depending on the URL information when the URL information is not included in the access blocking list, and stops access when the URL information is included in the access blocking list.

2. The optical disk reproducing apparatus according to claim 1, wherein the control unit registers the URL information, which is being accessed by the communication unit, in the access blocking list depending on a designation signal.

3. The optical disk reproducing apparatus according to claim 1, wherein when a registration button of a remote controller is depressed, the control unit registers the URL information, which is being accessed by the communication unit, in the access blocking list.

4. The optical disk reproducing apparatus according to claim 1, further comprising:
an OSD unit which outputs a synthesized signal with a display signal representing that a resource cannot be downloaded due to access blocking when access is stopped because the URL information is included in the access blocking list.

5. The optical disk reproducing apparatus according to claim 1, wherein the control unit starts downloading depending on the URL information only when an input password coincides with a registered password when the URL information is included in the access blocking list.

6. An optical disk reproducing method comprising:
outputting read information based on a reflected beam of a laser beam irradiated on an optical disk;
trying to extract URL information from the read information; and
when the URL information is extractable, comparing the URL information with URL information in an access blocking list, downloading a resource from a network through a communication unit depending on the URL information when the URL information is not included in the access blocking list, and stopping access when the URL information is included in the access blocking list.

7. The optical disk reproducing method according to claim 6, further comprising:
depending on a designation signal, the communication unit registers the URL information in the access blocking list.

8. The optical disk reproducing method according to claim 6, further comprising:
depressing a registration button of a remote controller to register the URL information, which is being accessed by the communication unit, in the access blocking list.

9. The optical disk reproducing method according to claim 6, further comprising:
outputting a display signal representing that a resource cannot be downloaded due to access blocking when access is stopped because the URL information is included in the access blocking list.

10. The optical disk reproducing method according to claim 6, wherein when the URL information is included in the access blocking list, downloading depending on the URL information is started only when an input password coincides with a registered password.
